(19) United States
(12) Patent Application Publication
(10) Pub. No.: US 2026/0158506 A1
(43) Pub. Date: Jun. 11, 2026

(54) WATER OUTLET DEVICE AND A SHOWER

(71) Applicant: Xiamen Songlin Technology Co., Xiamen (CN)

(72) Inventors: Shilong Wu, Xiamen (CN); Xiaolong Lin, Xiamen (CN); Youxian Hu, Xiamen (CN); Donghai Chan, Xiamen (CN)

(21) Appl. No.: 19/178,761

(22) Filed: Apr. 14, 2025

(30) Foreign Application Priority Data
Aug. 28, 2024 (CN) 202422102397.7

(51) Int. Cl. B05B 1/18; E03C 1/04

(52) U.S. Cl. CPC B05B 1/1823; B05B 1/1886; E03C 1/0408

(57) ABSTRACT

The application proposes a water outlet device, including a surface cover fitting with a fixed base, and a first water outlet structure and a second water outlet structure are arranged in a cavity in which the surface cover is fitted with the fixed base. The first water outlet structure and the second water outlet structure are arranged at intervals in a radial direction of the cavity, and the first water outlet structure is provided with water outlet cavities. The water outlet cavities are provided with first water outlet holes for continuous and/or intermittent water outputting, the second water outlet structure is provided with a driving assembly and outlet assemblies. The driving assembly is configured to drive the outlet assemblies to rotate with the help of water flow and forms dynamic massage water outputted at the second water outlet holes of the outlet assemblies.

### CROSS REFERENCE OF RELATED APPLICATION

This application claims priority of Chinese patent application number 202422102397.7, filed on Aug. 28, 2024, the entirety of which is incorporated by reference.

### TECHNICAL FIELD

The instant application belongs to the technical field of sanitary ware, in particular to a water outlet device and a shower.

### BACKGROUND

Shower is used as a common shower equipment in the daily life, its performance and function are crucial to the user's shower experience. However, the existing showers have obvious limitations in terms of the function of massage water. Most of the current showers on the market usually provide only one kind of massage water, and this single design is difficult to meet the diverse needs of different members of the family.

For example, some people may expect the massage water to achieve a dynamic coverage all-around for a more soothing and comprehensive massage experience, while others may prefer more intense, focused, and intermittent massage water to achieve deeper relaxation. However, the existing single massage shower cannot meet these different needs at the same time.

### SUMMARY

Aiming at the technical problems of single dynamic water discharge effect, disordered splash and general massage effect existing in the prior art, the application provides a water outlet device and a shower to solve the above technical problems.

According to the first aspect of the application, a water outlet device is provided, wherein comprising a surface cover fitting with a fixed base, and a first water outlet structure and a second water outlet structure are arranged in a cavity in which the surface cover fitting with the fixed base, the first water outlet structure and the second water outlet structure are arranged at intervals in a radial direction of the cavity, the first water outlet structure is provided with water outlet cavities, the water outlet cavities are provided with first water outlet holes for at least one of continuous or intermittent water outputting, the second water outlet structure is provided with a driving assembly and outlet assemblies, and the driving assembly is configured to drive the outlet assemblies to rotate with the help of water flow and forms a dynamic massage outlet water at the second water outlet holes of the outlet assemblies. The water outlet device can integrate intermittent pulse massage water and dynamic massage water, and can also choose regular continuous water according to the requirements to meet the massage or use needs of different people.

Preferably, the first water outlet structure is arranged at a peripheral side of the second water outlet structure. With this arrangement, the inside and outside of the surface cover can form different massage water outputting structures.

Preferably, an inner surface of the surface cover is provided with ring protrusions, the ring protrusions form a plurality of the water outlet cavities when the surface cover is fitted with the fixed base, and the first water outlet structure at least comprises first water outlet cavities arranged inside of the first water outlet structure and second water outlet cavities arranged outside of the first water outlet structure. With this arrangement, the device is able to provide water outlet cavities with different effluent modes

More preferably, the first water outlet cavities are provided with a first rotor, the first rotor is provided with a shielding part that is configured to block the first water outlet holes, the fixed base is provided with first water inlet holes matched with the first water outlet cavities, and the water impacts the first rotor after flowing through the first water inlet holes, leading inside water outlet holes matched with the first water outlet cavities to form the intermittent water outputting. With this arrangement, the device is able to create intermittent pulse massage water outputting.

More preferably, the fixed base is provided with second water inlet holes matched with the second water outlet cavities, and water flows through outside water outlet holes matched with the second water outlet cavities after flowing through the second water inlet holes to form continuous water output. With this arrangement, the device is able to realize an effluent mode of regular continuous water output.

Preferably, the outlet assemblies are provided with one or more of the second water outlet holes arranged to be inclined with rotation axes of the outlet assemblies, and an arrangement of the one or more of the second water outlet holes on the outlet assemblies meets conditions of:
setting a plane passing through axes of the one or more of the second water outlet holes on the outlet assemblies and perpendicular to a rotation plane as an installation surface of the outlet assemblies, any two adjacent installation surfaces of the outlet assemblies are set to be parallel to each other or at an angle of 360°/N, wherein N is a number of the outlet assemblies. With the clever design of the water outlet holes, the device can obtain a more diverse dynamic effect of water outputting than being with single water outlet hole, so as to obtain more massage enjoyment.

More preferably, each of the outlet assemblies is provided with three water outlet holes, the three water outlet holes have a same inclining direction and are arranged in a triangle, the installation surface is in a plane where a center line of the triangle is located, and the installation surfaces of any two adjacent outlet assemblies of the outlet assemblies are arranged at the angle of 360°/N. With this arrangement, the three water outlet holes can create dynamic spray without interfering with each other when rotating with the outlet assemblies, which makes the shape of the spray more beautiful, meanwhile, multiple water outlet holes also bring a more diverse massage experience.

More preferably, each of the outlet assemblies is provided with two water outlet holes, inclining directions of the two water outlet holes are opposite and present a trend of divergence from an upper end surface to a down end surface of the outlet assemblies, the axes of the two water outlet holes are in a same plane, and planes of the two water outlet holes on any adjacent outlet assemblies of the outlet assemblies are always parallel. With this arrangement, one outlet assembly can be form two spiral dynamic sprays, and the parallelism in the planes of the two outlet holes of the plurality of outlet assemblies can also make the spray morphology of the multiple outlet assemblies consistent.

More preferably, a central part of the fixed base is provided with one or more of the third water inlet holes, a middle of an inner cavity of the second water outlet structure is provided with a center column, the driving assembly has a rotational mechanism, the rotational mechanism is sheathed over the center column rotatably, the rotational mechanism comprises a second rotor, a deceleration plate and a turntable plate, the one or more of the third water inlet holes are inclined towards impellers of the second rotor, the second rotor is provided with an eccentric wheel, the eccentric wheel is matched with the deceleration plate, the deceleration plate and the second water outlet structure are respectively provided with an external gear and an internal gear, and the deceleration plate has an inner diameter size less than the second water outlet structure and a number of teeth of the external gear and a number of teeth of the internal gear are different. With this arrangement, the rapid rotational motion of the impeller can be slowed down to a desired rotational speed that is able to drive the outlet assemblies.

More preferably, upper circumferential surfaces of the outlet assemblies are provided with driven gears, lower circumferential surfaces of the outlet assemblies are provided with a sealing ring matched with the second water outlet structure by the way of a rotary seal, the turntable plate is provided with a driving gear meshing with the driven gears, the deceleration plate is provided with a plurality of driving columns, the turntable plate is provided with redundant holes matched with the plurality of driving columns correspondingly, a size of the redundant holes is greater than a diameter of the plurality of driving columns, which makes the deceleration plate drive the turntable plate to rotate around the center column when following the eccentric wheel to do a differential gear deceleration rotation, surfaces of the deceleration plate and the turntable plate are provided with outlet channels formed by a hollow structure. With this arrangement, the outlet assembly can be stably driven to rotate, while also having good rotary sealing characteristics.

Preferably, the device further comprises a water distribution assembly, the water distribution assembly is provided with a water inlet and a plurality of water outlets, the plurality of water outlets are respectively connected with water inlets of the first water outlet structure and the second water outlet structure, the water distribution assembly is also provided with a control mechanism, and the control mechanism controls the water inlet of the water distribution assembly to connect with one or more of the plurality of water outlets. The water inlet and the water inlet of the plurality of outlet assemblies can be connected through the water distribution assembly, and the connected state can be switched through the control mechanism.

More preferably, the water distribution assembly comprises a water distribution body and a water distribution base, the water distribution body is in sealed connection with the water distribution base, the water distribution body is provided with a plurality of water distribution channels, the control mechanism comprises a control part and a plurality of water distribution valve cores, and the control part controls the plurality of water distribution valve cores to switch a connection between the plurality of water distribution channels and the water inlets of the first water outlet structure and the second water outlet structure. With this arrangement, the device can flexibly switch on/off of different water distribution channels.

More preferably, the control part comprises a key, a push rod and a rotational structure, the rotational structure comprises a gear and a rotating shaft connected with each other, the key is fitted with the push rod by means of a tapering surface, the push rod is provided with a return spring, and the push rod is provided with a rack structure meshing with the gear, the rotating shaft is configured to control on/off of the plurality of the water distribution channels by driving the plurality of water distribution valve cores to move up and down when rotating. With this arrangement, it's convenient for users to switch different water distribution channels quickly to realize different massage water outputting effects.

More preferably, the device further comprises a water distribution cover, the water distribution cover is respectively fitted with the water distribution body and the fixed base hermetically, the water distribution cover is provided with ports matched with the plurality of water distribution channels of the water distribution body, and the water distribution cover is also provided with holes matched with water inlet holes of the fixed base. With this arrangement, different water distribution channels can fit with corresponding inlet holes hermetically.

According to the second aspect of the application, the application provides a shower, wherein comprises the device as described above. The water outlet device is arranged on the shower to make the shower have a variety of corresponding massage water effects.

In the water outlet device of the application, the first water outlet structure can realize intermittent water outputting and provide better massage rhythm and strength for the users. It can also be switched to achieve regular continuous water discharge in different water outlet cavities to meet the needs of routine use. The driving assembly in the second water outlet structure drives the outlet assemblies to rotate, and its inclined water outlet holes generate dynamic rotating water flow, which enhances the overall perception and massage experience of the splash. In addition, the application of the water outlet device to the shower significantly improves the function and use experience of the shower, and brings users a more rich, comfortable and personalized shower experience.

### BRIEF DESCRIPTION OF THE DRAWINGS

Comprising accompanying drawings to provide a further understanding of the embodiments and the drawings are incorporated into this specification and form part of this specification. The drawings illustrate the embodiments and are used in conjunction with the description to explain the principles of the present disclosure. Many expected advantages of other embodiments and embodiments will be easily understood because they are better understood by referring to the following detailed description. The components in the drawings are not necessarily proportional to each other. The same pictorial markings refer to corresponding similar parts.

FIG. 1 is a schematic diagram of the overall structure of a water outlet device according to an embodiment of the application;

FIG. 2 is a structural diagram of a surface cover of a specific embodiment of the application;

FIG. 3 shows a structural diagram of a fixed base of a specific embodiment of the application;

FIG. 4 is a structural diagram of a first rotor of a specific embodiment of the application;

FIG. 5 is a structural diagram of the water outlet surface cover of the second water outlet structure of a specific embodiment of the application;

FIGS. 6A-6B are structural diagrams of an outlet assembly according to a specific embodiment of the application;

FIGS. 7A-7B are schematic diagrams of the arrangement of an outlet assembly according to a specific embodiment of the application;

FIG. 8 is a structural diagram of a shower of an embodiment of the application;

FIG. 9 is an explosion diagram of a shower of an embodiment of the application;

FIGS. 10A-10B are schematic diagrams of a waterway of a specific embodiment of the application;

FIGS. 11A-11B are schematic diagrams of the water outputting pattern of a shower in a specific embodiment of the application.

### DETAILED DESCRIPTION OF THE DISCLOSURE

In the following detailed description, according to the attached drawings, the attached drawings form part of the detailed description and are shown by illustrative specific embodiments in which the application can be practiced. For this, it uses directional terms refer to the orientation of the described graph, such as “top”, “bottom”, “left”, “right”, “up”, “down”, etc. Because the embodiments may be positioned in a number of different orientations, the directional terms are used for the purposes of illustration and are not intended to be restrictive. It should be understood that other embodiments may be utilized or logical changes may be made without departing from the scope of the application. Therefore, the following detailed description shall not be used for limitation, and the scope of the application is limited by the attached claims.

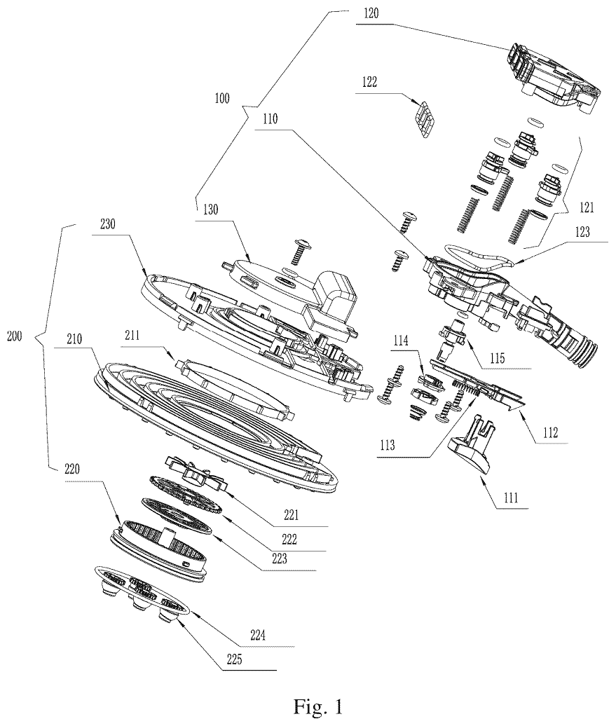

The application provides a water outlet device. FIG. 1 shows the overall structure diagram of the water outlet device according to an embodiment of the application. The water outlet device comprises a water distribution assembly 100 and a water outlet component 200, wherein the water distribution assembly 100 comprises a water distribution base 110, a water distribution body 120 and a water distribution cover 130. The water distribution base 110 is used to connect with the external inlet structure and is provided with a water distribution cavity inside. The water distribution body 120 is fitted with the water distribution cavity of the water distribution base 110 hermetically through a seal gasket 123. The water distribution cavity provides water distribution valve core assemblies 121 of which the number depends on the number of water distribution channels. In this application, the device comprises two-way distribution channels at least to be matched with different water entry requirements. In this embodiment, the three-way water distribution channels are taken as an example, that is, three groups of water distribution valve core assemblies 121 are arranged in the water distribution cavity. The water distribution valve core assembly 121 is a spool structure which controls the on/off by up and down and realizes automatic reset to close the valve through a spring. And a control mechanism is also arranged on the water distribution base 110, which is used to control the up and down of the water distribution valve core assemblies 121 to realize the communication between the water inlets on the water distribution base 110 and the corresponding water distribution channels. The control mechanism specifically comprises a button 111, a push rod 112, a gear 114 and a rotating shaft 115, wherein the button 111 is connected with the push rod 112, and the push rod 112 is provided with a rack structure matched with the gear 114, and the gear 114 and the rotating shaft 115 are connected with each other and rotate synchronously, and push the button 111 to make the push rod 112 move and to drive the gear 114 to rotate by means of tapering surface, the rotating shaft 115 rotates synchronously and pushes the water distribution valve core assemblies 121 move up and down, so as to achieve the gating of corresponding water distribution channels. In some other arrangements, besides the alternative gating way described above, it can also set multiple water distribution channels enabled at the same time for realizing different effects of water outputting, which only needs to change the way that the rotating shaft 116 drives one water distribution valve core assembly 121 separately to trigger and to drive multiple water distribution valve core assemblies at the same time. A plurality of ports of the water distribution channels are provided on water distribution body 120 (in this embodiment, three of that are taken as examples). The water distribution cover 130 is connected with the water distribution body 120 hermetically through the seal ring 122. The water distribution cover 130 is provided with waterways inside matched with the number of water distribution channels to achieve different water distribution effects with water outlet component 200.

In the specific embodiment, the water outlet component 200 comprises a first water outlet structure and a second water outlet structure arranged at intervals in a radial direction of the cavity. In this embodiment, the first water outlet structure is arranged at a peripheral side of the second water outlet structure, the first water outlet structure is provided with water outlet cavities, the water outlet cavities are provided with first water outlet holes for at least one of continuous or intermittent water outputting, the second water outlet structure is provided with a driving assembly and outlet assemblies, and the driving assembly is configured to drive the outlet assemblies to rotate with the help of water flow and forms dynamic massage water outputted at the second water outlet holes of the outlet assemblies to realize different inner and outer water outputting structures. The specific structure is described as follows: the device comprises a surface cover 210 and a fixed base 230. The surface cover 210 is fitted with the fixed base 230 to form a cavity accommodating the first water outlet structure and the second water outlet structure. And the surface cover 210 is also used as an outlet panel of the first water outlet structure and the middle part of that is hollowed out, the water outlet surface cover 220 of the second water outlet structure is arranged at the middle hollowing part of the surface cover 210 to achieve different effects of water outputting.

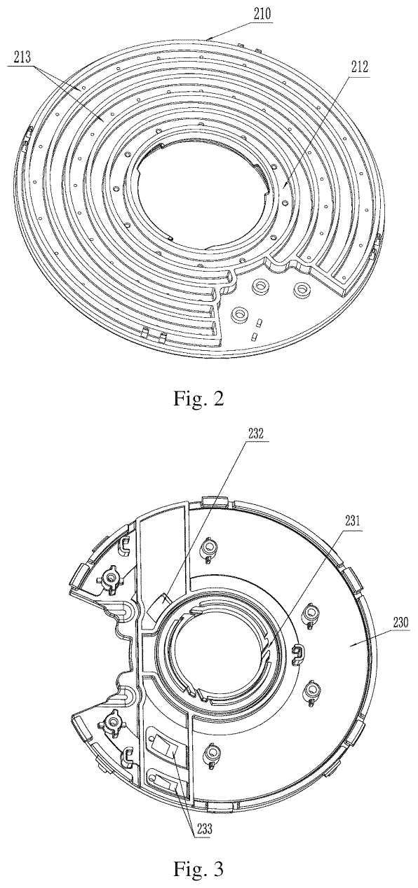

FIG. 2 shows the structural diagram of the surface cover of a specific embodiment of the application. As shown in FIG. 2, an inner surface of the surface cover is provided with multiple ring protrusions, the multiple ring protrusions form a plurality of the water outlet cavities when the surface cover 210 is fitted with the fixed base 230. In this embodiment, the device comprises first water outlet cavities 212 arranged inside and second water outlet cavities 213 arranged outside. Water outlet holes are arranged at intervals in the first water outlet cavities 212 and the second water outlet cavities 213. Combined with the structural diagram of a fixed base of a specific embodiment of the application shown in FIG. 3, the fixed base 230 provides a water inlet hole 232 and two water inlet holes 233 for oblique punching, which are corresponding to the first water outlet cavity 212 and the second water outlet cavity 213, respectively. The middle of the fixed base 230 also provides one or more of the water inlet holes 231 for oblique punching, the water inlet holes 231 connect with the inner water outlet structure of water outlet surface cover 220 of the second water outlet structure. The water distribution cover 130 is fixed with the fixed base 230, and the inner water distribution channels of the water distribution cover 130 marches with the water inlet holes for oblique punching above respectively, so as to realize the gating of water for different water inlet holes.

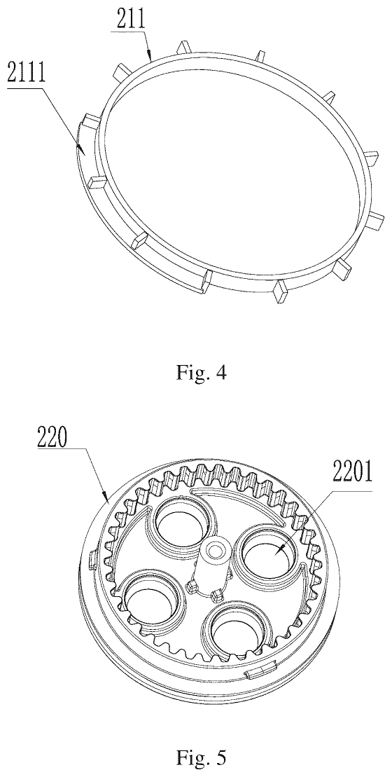

FIG. 4 shows a structural diagram of a first rotor of a specific embodiment of the application. As shown in FIG. 4, the outer surface of the first rotor 211 is provided with blades, and part of the blades of the first rotor 211 are connected with each other by a shielding part 2111. The first rotor 211 is set in the first water outlet cavity 212 inside the surface cover 210. When the water outlet cavity is gated, and the water impacts the first rotor 211 after flowing through the water inlet holes 232, and the shielding part 2111 blocks the water outlet holes at intervals when the rotor is rotating, realizing intermittent massage water sprays in an impulse type. If the second water outlet cavity 213 is gated controlled by the control mechanism, the water flow enters the second water outlet cavity 213 through the water inlet holes 233 and ejects from the water outlet holes in the second water outlet cavity 213 to achieve a conventional continuous effect of water outputting.

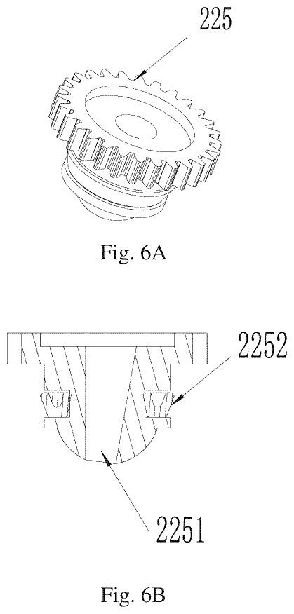

Continue with FIG. 5, FIG. 5 shows a structural diagram of the water outlet surface cover of the second water outlet structure of a specific embodiment of the application. In combination with FIG. 5 and FIG. 1, the water outlet surface cover 220 of the second water outlet structure is fitted with a fixed base 230 hermetically through a seal ring 224. The water outlet structure of the water outlet surface cover 220 of the second water outlet structure is a dynamic massage water outputting structure, wherein comprising outlet assemblies 225 and driving assembly which are arranged rotatably inside the water outlet surface cover 220 of the second water outlet structure. The outlet assemblies is provided with one or more of the second water outlet holes 2251 which are arranged to be inclined to the rotation axis of the water outlet assembly (as shown in the FIG. 6B). Accommodating cavities 2201 are arranged on the water outlet surface cover 220 for accommodating the outlet assemblies 225. The outlet assemblies are set in the accommodating cavities 2201 rotatably. Specifically, the driving assembly comprises a second rotor 221, a deceleration plate 222 and a turntable plate 223. One or more of the water inlet holes 231 are set in the middle of the fixed base 230 and points to the impellers on the surface of the second rotor 221. Preferably, three water inlet holes for oblique punching are set to ensure the smooth rotation of the second rotor 221. The bottom of the second rotor 221 is provided with an eccentric wheel, so that when the second rotor 221 rotates, the eccentric wheel rotates eccentrically relative to the second rotor 221. The deceleration plate 222 is arranged on the eccentric wheel to follow the eccentric wheel to do eccentric rotation movement. The circumferential surface of the deceleration plate 222 is provided with an outer gear structure. The outer gear structure meshes with the inner gear structure on the inner circumference surface of the water outlet surface cover 220 of the second water outlet structure, the size of the deceleration plate 222 is less than the inner diameter size of the water outlet surface cover 220 of the second water outlet structure, and a number of teeth of outer gear of the deceleration plate 222 and a number of teeth of the inner gear of the water outlet surface cover 220 of the second water outlet structure are different, which is to make the eccentric wheel of the second rotor 221 drive the deceleration plate 222 to achieve a differential gear deceleration rotation. The lower surface of the deceleration plate 222 is provided with a plurality of driving columns to drive the turntable plate 223 to rotate.

In a specific embodiment, the turntable plate 223 is provided with a plurality of redundant holes fitted with the drive columns on the deceleration plate 222, the size of which is slightly larger than the size of the drive columns to ensure that the eccentric rotating motion of the deceleration plate 222 turn into the rotating motion of the turntable plate 223 rotating around the center column in the inner cavity of the water outlet surface cover 220 of the second water outlet structure. The center of the bottom surface of the turntable plate 223 is also provided with a driving gear, which is used to drive the outlet assemblies 225 to rotate. Hollow structures are arranged on the surface of the deceleration plate 222 and the turntable plate 223, so that the water flow can enter the outlet assemblies 225 through the hollow structures after driving the second rotor 221 to rotate, and emit from the water outlet holes of the outlet assemblies 225.

Continue to refer to FIGS. 6A-6B, FIGS. 6A-6B show the structure diagrams of the outlet assembly according to a specific embodiment of the application. As shown in FIG. 6A, the upper part of the outlet assembly 225 is provided with driven gears structure matching the driving gear of the turntable plate 223. The central surface of the middle of the outlet assembly 225 is provided with an annular groove for placing the seal ring 2252 to ensure the tightness of the outlet assembly 225 when rotating in the accommodating cavity 2201. As shown in FIG. 6B, a second water outlet hole 2251 is arranged inside the outlet assembly 225, and the axis of the second water outlet hole 2251 is inclined relatively to the rotation axis of the outlet assembly 225, so that the water emitted from the second water outlet hole 2251 when the outlet assembly 225 rotates forms a dynamic effect of spiral water outputting.

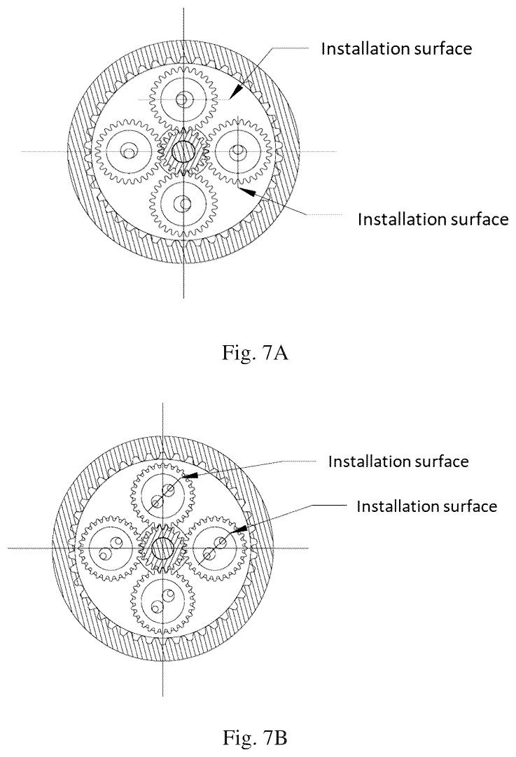

In a specific embodiment, the outlet assembly 225 and the second water outlet hole 2251 arranged on it are arranged to meet the following conditions: the plane which is passing through axes of one or more of the second water outlet holes 2251 on the outlet assembly 225 and is perpendicular to a rotation plane is set as the installation surface of the outlet assembly, and any two adjacent installation surfaces of the outlet assemblies are set to be parallel to each other or at an angle of 360°/N, wherein N is a number of the outlet assemblies. In this embodiment, the number of outlet assemblies is set as four, and the angle is 90°. Or the angle on the rotation plane may be shown as follows: the axes of the water outlet holes on the adjacent outlet assemblies between the projection lines of the rotation plane (namely the radial end face of the water outlet surface cover 220 of the second water outlet structure) always stay at an angle of 90 degrees. The details are shown in FIG. 7A.

In another embodiment, a plurality of second water outlet holes 2251 on the outlet assembly 225 may also be configured in other forms, wherein the water outlet holes of outlet assembly 225 meet the following conditions: The installation surfaces of any two adjacent outlet assemblies 225 are parallel to each other, which is specifically embodied as the center lines of a plurality of second water outlet holes 2251 of different outlet assemblies are always parallel on the rotation plane. The present embodiment is illustrated with two as example, but it should be recognized that more than two water outlet holes can be similarly provided with the above conditions. The details are shown in FIG. 7B.

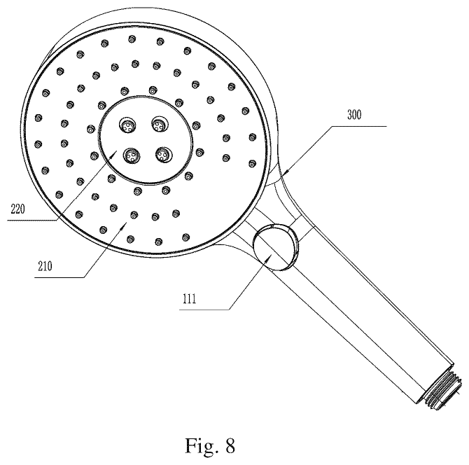

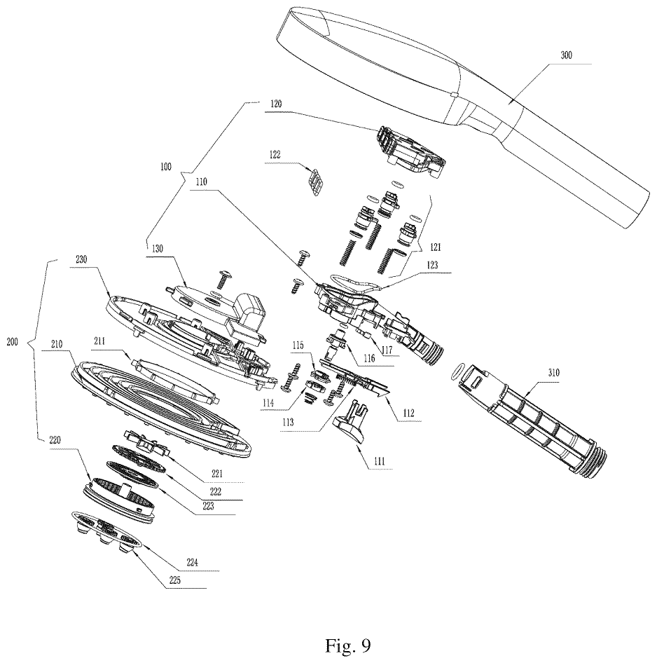

FIG. 8 shows the structural diagram of a shower of an embodiment of the application. As shown in FIG. 8, according to other aspects of the application, the water outlet device can also be arranged on the shower structure. Combined with the explosion diagram of a shower of an embodiment of the application shown in FIG. 9, the water distribution assembly 100 and the water outlet component 200 of the water outlet device are arranged on the shower body 300, and the handle of the shower body 300 is provided with an inlet mandrel 310, which is used for fitting with the water distribution base of the water outlet component 200 hermetically. The key of the control mechanism is arranged at the end of the handle near the surface cover to facilitate the user to switch the water. The shower has the function of switching between the multiple massage water mentioned above and the conventional water of the application.

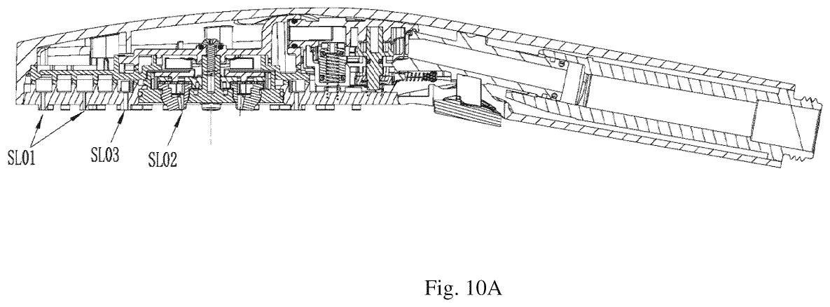

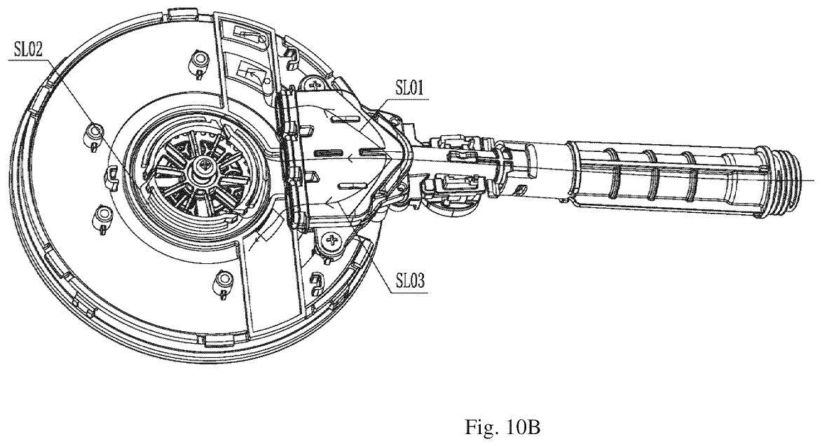

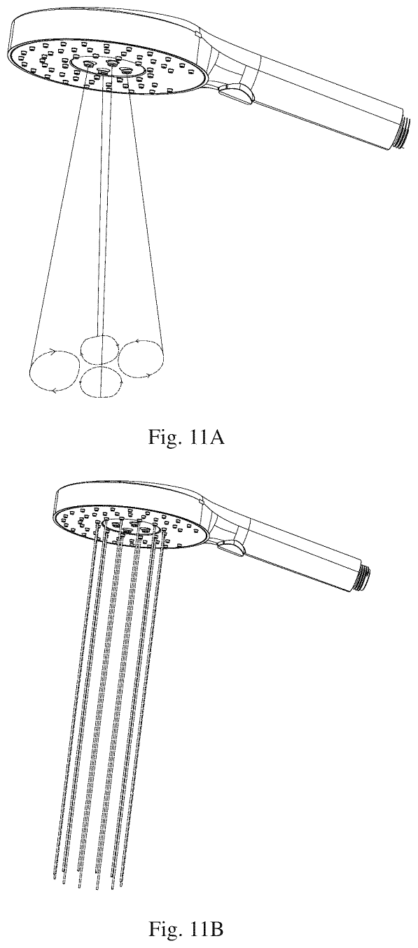

The following is a brief description of the principle of the shower in combination with the waterway diagram of a specific embodiment of the application shown in FIGS. 10A-10B, and the water outputting pattern diagram of a specific embodiment of the application shown in FIGS. 11A-11B. As shown in FIGS. 10A and 10B, when the user triggers the waterway SL01 to be connected through the button of the control mechanism, the water flow enters the second water outlet cavity 213 through the water outlet holes 233 to achieve the effect of conventional sprinkling water. When the user triggers the waterway SL02 to be gated by the button of the control mechanism, the water flow impacts the second rotor 221 through the water outlet holes 231 to make the second rotor 221 rotate, and the deceleration plate 222 realizes the differential gear deceleration rotation with the coordination between the corresponding inner teeth on the water outlet surface cover 220 of the second water outlet structure and the outer teeth of the outer ring and under the action of the eccentric wheel. The deceleration plate 222 then drives the turntable plate 223 to rotate, and the driving gear on the turntable plate 223 engage with the outer gears on the multiple outlet assemblies 225, and leads multiple water outlet assemblies 225 to rotate synchronously, the water flows through the outlet holes of the outlet assemblies to form a spiral dynamic effect of water outputting, as shown in the effect diagram in FIG. 11A. When the user triggers the waterway SL03 by the button of the control mechanism, the water flow enters the first water outlet cavity 212 through the water outlet holes 232, and impacts the first rotor 211 to rotate, and the shielding part 2111 on the first rotor 211 intermittently blocks the water outlet hole to achieve the effect of intermittent water outputting, as shown in FIG. 11B.

The specific implementation modes of the application are described above, but the protection scope of the application is not limited. The techniques that any technical personnel familiar with the technical field can easily think of changes or replacements within the technical scope disclosed by the application, shall be covered within the protection scope of the application. Therefore, the protection scope of the application shall be subject to the protection scope of the claims.

In the description of the application, it should be understood that the orientation or position relationship indicated by the terms “up”, “down”, “inside”, “outside”, etc., is based on the orientation or position relationship shown in the attached drawings, and they are only used for the purpose of facilitating the description of the application and simplifying the description, but not to indicate or imply that the device or element referred to must have a specific orientation or construction and operation in a specific orientation. Therefore, it cannot be understood as a limitation of the application. The wording ‘comprise’ does not exclude the presence of elements or steps not listed in the claim. The expression “one” or “one” before a component does not preclude the existence of more than one such component. The simple fact that certain measures are included in different dependent claims does not indicate that a combination of these measures cannot be used for improvement. Any reference symbol in a claim shall not be construed as limiting the scope.

What is claimed is:

1. A water outlet device, comprising a surface cover fitting with a fixed base, wherein a first water outlet structure and a second water outlet structure are arranged in a cavity in which the surface cover is fitted with the fixed base, the first water outlet structure and the second water outlet structure are arranged at intervals in a radial direction of the cavity, the first water outlet structure is provided with water outlet cavities, the water outlet cavities are provided with first water outlet holes for at least one of continuous or intermittent water outputting, the second water outlet structure is provided with a driving assembly and outlet assemblies, and the driving assembly is configured to drive the outlet assemblies to rotate with the help of water flow and forms dynamic massage water outputted at second water outlet holes of the outlet assemblies.

2. The device according to claim 1, wherein the first water outlet structure is arranged at a peripheral side of the second water outlet structure.

3. The device according to claim 1, wherein an inner surface of the surface cover is provided with ring protrusions, the ring protrusions form a plurality of the water outlet cavities when the surface cover is fitted with the fixed base, and the first water outlet structure at least comprises first water outlet cavities arranged inside of the first water outlet structure and second water outlet cavities arranged outside of the first water outlet structure.

4. The device according to claim 3, wherein the first water outlet cavities are provided with a first rotor, the first rotor is provided with a shielding part that is configured to block the first water outlet holes, the fixed base is provided with first water inlet holes matched with the first water outlet cavities, and inside water outlet holes matched with the first water outlet cavities are configured to form the intermittent water outputting while water impacts the first rotor after flowing through the first water inlet holes.

5. The device according to claim 3, wherein the fixed base is provided with second water inlet holes matched with the second water outlet cavities, and outside water outlet holes matched with the second water outlet cavities are configured to form continuous water output after water flows through the second water inlet holes.

6. The device according to claim 1, wherein the outlet assemblies are provided with one or more of the second water outlet holes arranged to be inclined with rotation axes of the outlet assemblies, and an arrangement of one or more of the second water outlet holes on the outlet assemblies meets conditions of:
setting a plane passing through axes of the one or more of the second water outlet holes on the outlet assemblies and perpendicular to a rotation plane as an installation surface of the outlet assemblies, and
any two adjacent installation surfaces of the outlet assemblies are set to be parallel to each other or at an angle of 360°/N, wherein N is a number of the outlet assemblies.

7. The device according to claim 6, wherein each of the outlet assemblies is provided with three water outlet holes, the three water outlet holes have a same inclining direction and are arranged in a triangle, the installation surface is in a plane where a center line of the triangle is located, and the installation surfaces of any two adjacent outlet assemblies of the outlet assemblies are arranged at the angle of 360°/N.

8. The device according to claim 6, wherein each of the outlet assemblies is provided with two water outlet holes, inclining directions of the two water outlet holes are opposite and present a trend of divergence from an upper end surface to a down end surface of the outlet assemblies, axes of the two water outlet holes are in a same plane, and planes of the two water outlet holes on any adjacent outlet assemblies of the outlet assemblies are always parallel.

9. The device according to claim 6, wherein a central part of the fixed base is provided with one or more of third water inlet holes, a middle of an inner cavity of the second water outlet structure is provided with a center column, the driving assembly has a rotational mechanism, the rotational mechanism is sheathed over the center column rotatably, the rotational mechanism comprises a second rotor, a deceleration plate and a turntable plate, the one or more of third water inlet holes are inclined towards impellers of the second rotor, the second rotor is provided with an eccentric wheel, the eccentric wheel is matched with the deceleration plate, the deceleration plate and the second water outlet structure are respectively provided with an external gear and an internal gear, and the deceleration plate has an inner diameter size less than the second water outlet structure and a number of teeth of the external gear and a number of teeth of the internal gear are different.

10. The device according to claim 9, wherein upper circumferential surfaces of the outlet assemblies are provided with driven gears, lower circumferential surfaces of the outlet assemblies are provided with a sealing ring matched with the second water outlet structure by the way of a rotary seal, the turntable plate is provided with a driving gear meshing with the driven gears, the deceleration plate is provided with a plurality of driving columns, the turntable plate is provided with redundant holes matched with the plurality of driving columns correspondingly, a size of the redundant holes is greater than a diameter of the plurality of driving columns, which makes the deceleration plate drive the turntable plate to rotate around the center column when following the eccentric wheel to do a differential gear deceleration rotation, surfaces of the deceleration plate and the turntable plate are provided with outlet channels formed by a hollow structure.

11. The device according to claim 1, further comprising a water distribution assembly, wherein the water distribution assembly is provided with a water inlet and a plurality of water outlets, the plurality of water outlets are respectively connected with water inlets of the first water outlet structure and the second water outlet structure, the water distribution assembly is also provided with a control mechanism, and the control mechanism controls the water inlet of the water distribution assembly to connect with one or more of the plurality of water outlets.

12. The device according to claim 11, wherein the water distribution assembly comprises a water distribution body and a water distribution base, the water distribution body is in sealed connection with the water distribution base, the water distribution body is provided with a plurality of water distribution channels, the control mechanism comprises a control part and a plurality of water distribution valve cores, and the control part controls the plurality of water distribution valve cores to switch a connection between the plurality of water distribution channels and the water inlets of the first water outlet structure and the second water outlet structure.

13. The device according to claim 12, wherein the control part comprises a key, a push rod and a rotational structure, the rotational structure comprises a gear and a rotating shaft connected with each other, the key is fitted with the push rod by means of a tapering surface, the push rod is provided with a return spring, the push rod is provided with a rack structure meshing with the gear, and the rotating shaft is configured to control on/off of the plurality of water distribution channels by driving the plurality of water distribution valve cores to move up and down when rotating.

14. The device according to claim 12, further comprising a water distribution cover, wherein the water distribution cover is respectively fitted with the water distribution body and the fixed base hermetically, the water distribution cover is provided with ports matched with the plurality of water distribution channels of the water distribution body, and the water distribution cover is also provided with holes matched with water inlet holes of the fixed base.

15. A shower, comprising the water outlet device according to claim 1.
